(19) United States
(12) Patent Application Publication
(10) Pub. No.: US 2005/0219988 A1
(43) Pub. Date: Oct. 6, 2005

(54) Optical pickup apparatus

(75) Inventors: Yuichi Atarashi, Tokyo (JP); Kohei Ota, Tokyo (JP); Katsuya Yagi, Tokyo (JP); Junji Hashimura, Sagamihara-shi (JP); Tohru Kimura, Tokyo (JP); Katsuya Sakamoto, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/092,896

(22) Filed: Mar. 30, 2005

(30) Foreign Application Priority Data
Apr. 2, 2004 (JP) JP2004-110448

(51) Int. Cl. G11B 7/00

(52) U.S. Cl. 369/112.08; 369/112.23

(57) ABSTRACT

An optical pickup apparatus comprises a first, second and third light beam sources for emitting first light beams having wavelengths λ1, λ2 and λ3 (λ1<λ2<λ3) for a first, second and third recording medium respectively having a first, a second and a third protective layers of thickness t1, t2 and t3, an objective optical lens for converging the first, the second and the third light beams onto respective recording surfaces of the first, second and the third recording media, a tracking device for moving the objective optical lens, a first divergent angle changing element for changing a divergent angle of light beams, which is capable of moving in the optical axis direction and placed in an optical path, and a coma aberration correction element for correcting coma aberration caused when the tracking device moves the objective optical element.

This application is claimed priority from Japanese Patent Application No. 2004-110448 Apr. 2, 2004, which is incorporated hereinto by reference.

The present invention relates to an optical pickup apparatus and optical elements used for the optical pickup apparatus, particularly the optical pickup apparatus for recording information onto an optical disc having a plurality of layers.

### FIELD OF THE INVENTION

Optical pickups (they are also called an optical head or an optical pickup apparatus) for reproducing and recording information from and onto an optical information recording medium such as CD (Compact Disc), DVD (Digital Video Disc, or Digital Versatile Disc) have been developed, manufactured and wildly used.

### BACKGROUND OF THE INVENTION

In recent years, research and development of the industrial standard for optical information recording medium on which light beam having around 405 nm wavelength is applied to record high density information have been conducted.

In these optical pickups, light beams from a light beam source (in many cases, a laser diode is used) are converged and formed into a focal point on the information recording surface of an optical disc after passing through an optical element system structured by a beam forming prism, a collimated lens, a beam splitter and an objective lens, etc. Reflected light beams reflected by information pits (it may be simply called a pit) on the recording surface are converged onto an optical sensor after passing back through the optical element system and converted into electric signals. When light beams are reflected by the information recording pits, the aspect of the reflected light beams is changed according to the shape of the information recording pits. By using this change of the aspect of the reflected light beams is utilized to discriminate the information of “0” and “1”. A protective layer (it may be called a plastic protective layer, a cover glass or simply a substrate) is provide on the information recording layer.

When recording information onto a recording medium such as CD-R and CD-RW, a laser beam spot is formed on the recording medium and it causes thermal chemical change with the recording medium of the recording surface. In the case of CD-R, irreversible change of thermal diffusion dye forms information recording pits which is the same shape of the information recording pits described above. In the case of CD-RW, since a phase-change type material is adopted, the material is reversibly changed between a crystal state and a non-crystal state so that information can be rewritten.

An optical pickup for reproducing information from an optical disc conforming CD standard has an object lens having NA (Numerical Aperture) of around 0.45 and wavelength used as light beam source is around 785 nm. With regard to a recording optical head, in many cases, NA is set around 0.50 and thickness of the protective layer of optical disc conforming to CD standard is 1.2 mm.

As for an optical information recording medium, CD is widely used. In last several years, DVD has become popular. Comparing with CD, the thickness of the protective layer of DVD is set thinner than that of CD and the information pit size is set smaller than that of CD so that the information capacity of DVD is around 4.7 GB (gigabytes) while the information capacity of CD is around 600-700 MB (megabytes).

The basic of an optical pickup apparatus for reproducing information from an optical disc conformable to DVD standard is the same as an optical pickup for CD. However as described above, since the information pit size is smaller than that of CD, NA of an objective lens is set around 0.60 for reproducing and 0.65 for recording.

Recording type optical discs, such as DVD-RAM and DVD-RW/R, conformable to DVD standard have already been in practice. The basics of these discs are the same as that of CD standard.

Regarding to a large capacity optical discs using a blue-violet laser beams, wavelength being around 405 nm, two types of industrial standards have been proposed. In one of these two standard is Blu-Ray Disc, in which the thickness of the substrate of the disc is 0.1 mm and NA of an objective lens is 0.85 are proposed. Another is HD DVD, in which the thickness of the substrate of a disc is 0.65 mm and NA of an objective lens is 0.65 are proposed. The capacity of each disc is around 20 GB (Gigabytes). With regard to the basics of signal readout and recording from and to these discs are the same as that of conventional standards described above.

The compatibility between the large capacity optical disc using blue-violet laser beams and conventional CD/DVD is required. Particularly, the same objective optical element for reproducing and recording information from and to those discs is required.

In this case, spherical aberration correction based on the difference of substrate thickness of the medium and aberration correction based on the wavelength difference are necessary. SO far, various methods have been proposed however, it is not easy to secure the compatibility between these three media. In general, an objective optical element is designed based on a medium having the largest NA (Numerical Aperture) and some corrections are applied for other media.

In Japanese Patent Application Open to Public Inspection No. 2001-60336, a technology for forming an optimum focal spot for respective optical discs differing in thickness of a protective layer by using a diffractive structure which is one of the optical path difference giving structure.

In Japanese Pant Application Open to Public Inspection No. 2001-60336, a technology for forming an optimum focal spot for respective optical discs differing in thickness of a protective layer by changing a magnification ratio of beams incident to an objective lens by moving a collimator lens.

In general, it is preferable that light beams incident to an objective lens are infinite parallel beams. Divergent light beams from a light source is arranged to be formed into parallel light beams by passing through a collimator lens and guided to an objective lens. In this case, there is a merit that light beam amount loss caused by eclipse can be prevented by placing an optical element having diffraction structure is provided in the light beam path.

However, as technology disclosed in Japanese Patent Application Open to Public Inspection No. 2001-60336, when trying to eliminate the differences between these three protective layers in thickness, different order diffraction light beams are required which results in lower diffraction efficiency, lack of light beam amount and problems associated with focal spot formation.

Further, since the correction amount of CD which has the most thickest substrate and the least NA becomes large, when guiding infinite parallel light beams into the objective optical element, the problem that WD (working distance: it is called “operational distance” which is a distance between the most convex portion of an objective lens and the surface of a disc) becomes short. If the WD is short, there is a possibility that an objective optical element hits the surface of a disc, which is not preferable for the structure of an optical pickup.

Aiming at low cost and less space factor optical pickups, an optical pickup structure having an objective optical element into which finite diversity light beams are guided becomes popular. Regarding to “a trend toward the finite light beams”, it has relatively less problem when the optical pickup apparatus write/reads information onto/from a single optical recording medium.

It is possible to form a focal spot by canceling the spherical aberration caused by the substrate thickness differences by applying spherical aberration generated by changing the magnifying power of light beams incident to an objective optical element as disclosed in Japanese Pant Application Open to Public Inspection No. 2001-60336. In this case, it is possible to secure the WD by particularly using a finite divergence light beams for CD.

However, when finite divergent light beams are guided into an objective lens, and the objective lent moves in the tracking direction to follow a track on which the objective lens follows, the light beams incident to the objective lens are obliquely guided into the object lens, coma aberration occurs. When infinite parallel light beams are guided into the objective lens, coma aberration does not occur. Particularly, in the case of a objective optical element having a compatibility of recording and reproducing information onto and from media conforming to plural industrial standards, there is a problem that the larger correction amount from a reference objective lens, the more deterioration of tracking characteristics.

However, in the technology described above, no disclosure about the deterioration of tracking characteristics and their recoveries are found.

### SUMMARY OF THE INVENTION

An object of the present invention is to provide an optical pickup system having a singular optical element having compatibility over the three kinds of media described above and securing a necessary working distance without deteriorations of tacking characteristic even for a medium having a thickest substrate.

As a result of inventor's efforts, inventors have found that in order to correct aberration caused by the tracking movement of the objective optical element, another aberration is intentionally generated by moving another optical element placed in the optical path and applied so that the aberration is canceled out and as a result a preferable wave surface is formed.

According to the configuration of the optical pickup described above, a diffraction element having a fine structure is not necessary. It becomes possible to read a plurality of recording media with a single objective optical element while securing necessary WD (Working Distance) and keeping a preferable tracking characteristic.

In accordance with one aspect of the present invention, an optical pickup apparatus comprises a first light beam source for emitting first light beams having wavelength λ1 for reproducing and recording information from and onto a first recording medium having a first protective layer of thickness t1,
a second light beam source for emitting second light beams having wavelength λ2 (λ1<λ2) for reproducing and recording the information from and onto a second recording medium having a second protective layer of thickness t2 (t1<t2),
a third light beam source for emitting third light beams having wavelength λ3 (λ2<λ3) for reproducing and recording the information from and onto a third recording medium having a third protective layer of thickness t3 (t2<t3),
an objective optical lens for converging the first light beams, the second light beams and the third light beams onto respective recording surfaces of the first recording medium, the second recording medium and the third recording medium,
a tracking device for moving the objective optical lens in a tracking direction being perpendicular to an optical axis direction of the objective optical lens,
a first divergent angle changing element for changing a divergent angle of light beams incident to the objective optical element, the divergent angle changing element being capable of moving in the optical axis direction and placed in
an optical path from the first, second and third light beam sources to the objective optical element, and
a coma aberration correction element for correcting coma aberration caused when the tracking device moves the objective optical element, the coma aberration correction element being placed in the optical path.

In accordance with another aspect of the invention, the optical pickup apparatus described above,
wherein the coma aberration correction element is second divergent angle changing element for generating spherical aberration corresponding to a moving amount of the coma aberration correction element placed in the optical path,
the first divergent angle changing element moves in an optical axis direction of the first divergent angle changing element corresponding to a information recording medium to be reproduced from or recorded to so that the first divergent angle changing element cancels out spherical aberration caused by a difference between the first protective layer, the second protective layer and the third protective layer, and
the second divergent angle changing element moves in an optical axis direction of the second divergent angle changing element so as to cancel out the coma aberration caused when the tracking device moves the objective optical element.

In accordance with another aspect of the optical pickup apparatus described above,
wherein the coma aberration correction element is provided in between the first, secondhand third light beam sources, and the objective optical element, the coma aberration correction element being an aberration element for generating spherical aberration based on an amount of electrical signal implied to the coma aberration element,
the first divergent angle changing element moves in the optical axis direction corresponding to a information recording medium so that the first divergent angle element cancels out first spherical aberration caused by a difference between the first protective layer, the second protective layer and the third protective layer, and
the electrical signal is changed so as to cancel out the coma aberration caused when the tracking device moves the objective optical element.

### BRIEF DESCRIPTION OF THE DRAWING

FIG. 1 illustrates a block diagram of an optical pickup apparatus of the first embodiment of the present invention.

FIG. 2 illustrates another block diagram of an optical pickup apparatus of the first embodiment of the present invention.

FIG. 3 illustrates a block diagram of the second embodiment of the present invention.

FIG. 4 illustrates a block diagram of the third embodiment of the present invention.

FIG. 5 illustrates another block diagram of the third embodiment of the present invention.

FIG. 6 illustrates a block diagram of the fourth embodiment of the present invention.

FIG. 7 illustrates another block diagram of the fourth embodiment of the present invention.

FIG. 8 illustrates a block diagram of the fifth embodiment of the present invention.

FIG. 9 illustrates another block diagram of the fifth embodiment of the present invention.

### DETAILED DESCRIPTION OF THE PREFERRED EMBODIMENT

The details of this invention will be described below in reference with the accompanying drawings, but the samples of this invention are not intended as a definition of the limits of the invention.

### First Embodiment

The first aspect to seventh aspect of the present invention will be explained below.

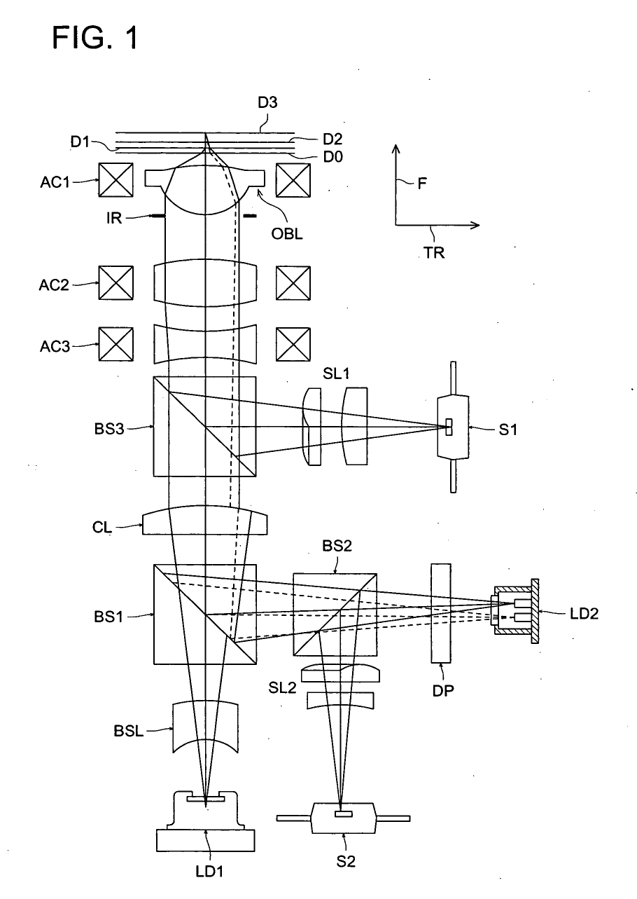

Referring to FIG. 1, a basic optical pickup configuration related to the present invention will be explained.

This embodiment is for an optical pickup apparatus using a blue-violet laser light source of 405 nm as a wavelength, which can be used for three formats of “high density optical disc,” DVD, and CD. In this embodiment, it is assumed that a first information recording medium is a “high density optical disc” whose protective layer is 0.1 mm thick (t1), a second information recording medium is a DVD whose protective layer is 0.6 mm thick (t2), and a third information recording medium is a CD whose protective layer is 1.2 mm thick (t3). In the drawing, D1, D2, and D3 respectively denote an information recording surface and D0 denotes the surface of the protective layer.

FIG. 1 shows a block diagram of an optical pickup apparatus which is related to this invention.

Laser diode LD1 is a first light source using a blue-violet laser whose wavelength λ1 is 407 nm. The wavelength can be in the range of 390 nm to 420 nm. Laser diodes LD2 of a second light source (for DVD) and LD3 of a third light source (for CD) are assembled in a single package. In other words, it is a 2-laser 1-package light source unit. The second light source uses a red laser of 655 nm (as the wave length λ2). The wavelength can be in the range of 630 nm to 680 nm. The third light source uses an infrared laser of 785 nm (as the wavelength λ3). The wavelength can be in the range of 750 nm to 800 nm.

One of the light sources in the package is adjusted to position on the optical axis and the other light source is a little away from the optical axis. This makes a tall image. There have been some well-known technologies to improve this characteristic and they can be applied if necessary. This embodiment uses correction plate DP to improve this characteristic. Correction plate DP contains a grating to correct a deviation from the light axis and collect light to sensor S2.

Beam splitter BS1 guides light beams from LD1 and LD2 to objective optical element OBL.

To improve the quality of light beams, the light beams from LD1 goes into beam shaper BSL, enters collimator CL via beam splitter BS1, is collimated there into an infinite parallel light, and enters a glass-made single-lens objective optical element OBL (closest to the optical disc) via beam expander BE which is made up with concave and convex lenses. OBL is a lens optimized for the “high density optical disc.” OBL forms a light spot on the surface of the first light information recording medium through its protective layer. The light reflected on the surface of the first light information recording medium returns along the same route and collects into sensor S1 by BS3 via sensor lens SL1. This sensor converts the light into an electric signal.

A quarter-wave plate (not shown in the drawing) is provided between beam expander BE and objective optical element OBL. This deviates the phase of round-trip light by half wavelength and thus changes the direction of polarization. Therefore, the returning light beam changes its traveling direction by BS3.

The concave and convex lenses of beam expander BE are respectively driven by actuators AC2 and AC3 to individually go forward and backward along the optical axis direction. In other words, by driving one of the lenses to go forward and backward, we can change the diverging light beam to be fed into the OBL into a light beam of a limited diverging angle, eliminate spherical aberrations caused by differences in thickness of recording media layers and spherical aberrations caused by differences in service wavelengths. This enables the optical pickup apparatus to handle three formats of recording media. In this case, this element is a first divergent angle changing element.

Beam shaper BSL has a curvature in the direction perpendicular to the optical axis and another curvature in the direction perpendicular to the direction. (In other words, the curvatures of beam shaper BSL are not symmetrical around the optical axis.)

Due to the structural limit of the semiconductor light source, the light beam out-going from the light source has an angle of divergence in the direction perpendicular to the optical axis and another angle of divergence in the direction perpendicular to this direction. The light beam shows an elliptical section when viewed along the light axis. This light beam is not good for optical discs. So, beam shaper BSL gives different refractions to the light beams in the directions to make the out-going light beam have an approximately circular beam section.

Although beam shaper BSL is provided in the optical path of LD1, it can be provided in the optical path of LD2.

In the similar way to LD1, the light beam from LD2 forms a light spot on the optical disc (second light information recording medium and third light information recording medium). The light is reflected on the disc surface and finally enters sensor S2. This operation is basically the same as the operation of LD1 except that the optical path is matched by BS2.

In this drawing, objective optical element OBL is a single glass lens but it can be made up with two or more optical elements. For embodiment, objective optical element OBL can be a 2-lens unit which is made up with a plastic lens and a glass lens. This configuration has a merit to improve the basic off-axis characteristics.

This drawing shows that the light beam from each LD forms a light spot on the information recording surface via the protective layer of the optical disc. However, since recording media to be written and read of each standard has a fixed distance between the light source and the protective layer surface of the disc, the basic position (reference position) of the objective optical element is switched by actuator AC1 and the objective optical element is driven to move to and from the reference position along the optical axis F for converging. AC1 is a 2-axis actuator and also works as a tracking device that sways the objective optical element in an optical axis direction and TR (Tracking direction) being perpendicular to the optical axis direction.

The numerical aperture required by objective optical element OBL is dependent upon pit sizes and the thickness of the protective layer of each light information recording medium. Here we assume the numerical aperture for CDs is 0.45 and the numerical apertures for DVDs and “high density optical discs” are 0.85. The numerical aperture for CDs can be in the range of 0.43 to 0.50 and that for DVDs can be in the range of 0.58 to 0.68.

Diaphragm IR is provided to cut off unwanted light.

As described above, the spherical aberration caused by the differences in disc thickness is corrected, for example, by driving AC2 to move the convex lens of the first divergent angel changing element BE forward and backward and changing the angle of divergence of a light beam which enters objective optical element OBL. In this case, the light beam going through the convex lens changes the angle of divergence. (Third aspect of the invention).

In this case, when OBL (Objective Lens) tracks, the diverging light beams having a spherical aberration diagonally enters OBL and this generates a coma aberration. Therefore, the tracking characteristic goes worse as the disc becomes thicker.

To eliminate this, AC3 is driven to move the concave lens in a second divergent angle changing element BE (Beam Expander) forward and backward to generate a spherical aberration. As a result, the coma-aberration is eliminated. It is natural that the spherical aberration which is generated here is smaller than the spherical aberration which is generated when light beam of spherical wave are applied to OBL. (Fifth aspect of the invention).

Further, since the coma aberration is corrected by a spherical aberration, the spherical aberration must be greater than what is required for correction. (Sixth aspect of the invention).

To generate such a spherical aberration, the second divergent angle changing element should preferably have an aspheric surface, particularly an aspheric surface whose quartic aspheric surface coefficient is not 0. (Seventh aspect of the invention).

Further for correction of the other aberrations, it is preferable at least one of sextic, eightic and tentic aspheric surface coefficients is not 0. (Eighth aspect of the invention).

Although this embodiment uses BE components as the first and second divergent angle changing elements, it is possible to change their roles and use other elements.

For example, when the concave lens of beam expander BE is selected as the first divergent angle changing element, the light beams can be outputted without changing its divergent angle. This can make the adjustment easier. (Fourth aspect of the invention) In this case, the compatibility over three type of disc with one optical pickup apparatus can be attained as the divergent angle of a light beam going into OBL changes.

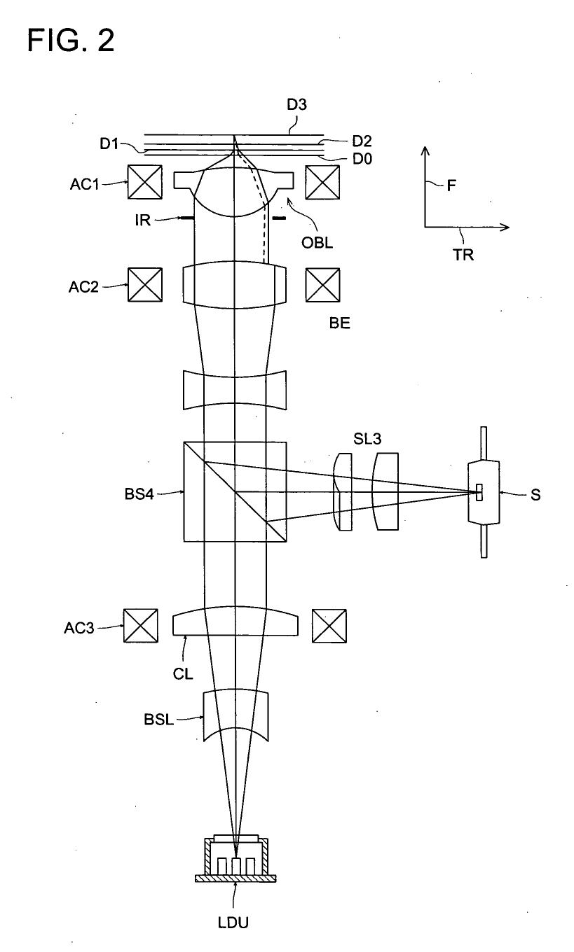

As shown in FIG. 2, it is possible to use a light source unit of 3-lasers in a 1-package type which contains first, second and third light sources in a package. The optical characteristc of this unit is approximately equal to that of FIG. 1. This unit can reduce the number of optical elements and build a simple optical system.

For improvement, it is possible to reduce the quantity of sine condition violation of the objective optical element, particularly on the third information recording medium.

### Second Embodiment

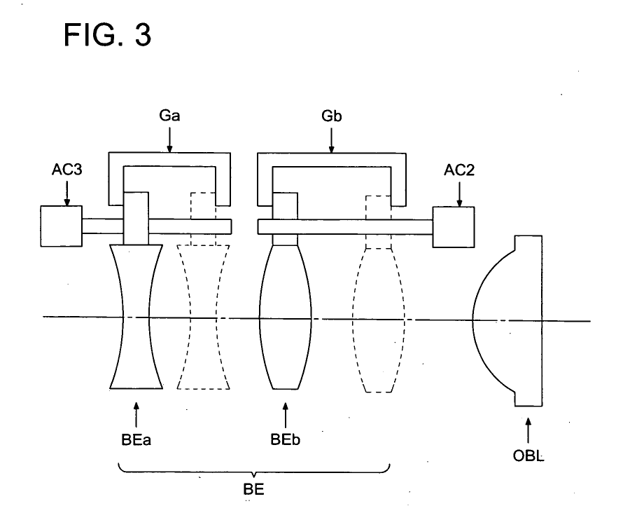

Referring to FIG. 3, from eighth to nineteenth aspects of the invention will be explained below.

FIG. 3 shows a variation of the first aspect of the present invention which uses linear actuators AC2 and AC3 to improve the driving structure. In FIG. 1, beam expander BE is of the butting type. To correct the spherical aberration caused by differences in thicknesses of protective layers or the spherical aberration caused by differences in service wavelengths, this embodiment uses beam expander BE which is made up with a negative lens (concave lens) BEa and a positive lens (convex lens) BEb. Negative and positive lenses BEa and BEb can move independently along the optical axis sequentially from the light source. The correction of the spherical aberration caused by differences in thicknesses of protective layers is the same in the basic configuration and the operation as that of the first embodiment.

This embodiment like the first embodiment uses “high density optical disc,” DVD, and CD as light information recording media. The light sources of 407 nm, 655 nm, and 785 nm as the service wavelengths are used for recording and reproduction of the media. This embodiment assumes that the BD is of the 2-layer type. The distances (depths) between the disc surface and respective information recording surfaces L0 and L1 are respectively 0.100 mm and 0.075 mm.

In objective optical element OBL, the spherical aberration is corrected corresponding to “high density optical disc” L0 whose protective layer is 0.100 mm thick when infinite light of 407 nm (as the wavelength) is applied. The objective optical element contains a wavelength selective diffraction structure (not shown in the drawing). The objective optical element is a compatible objective element which also corrects the spherical aberration of the DVD when infinite light of 655 nm (as the wavelength) is applied.

In the objective optical element, the spherical aberration is corrected when diverging light beams of a low divergent degree is applied to L1 of BD, the spherical aberration is corrected when a diverging light beam of a high divergent degree is applied to CD.

Each of negative lens BEa and positive lens BEb of beam expander BE can move along the optical axis and take at least two positions (one in the light source side and the other in the objective optical element side). Further, position regulating members Ga and Gb are provided to respectively regulate the lens positions in a butting manner.

It is also possible to provide an encoder and control lens positions to stop the lens at an arbitrary or predetermined position. When negative lens BEa is near the light source and positive lens BEb is near the objective optical element, positive lens BEb emits infinite light. With regard to the light beam of 407 nm (as the wavelength) passing through the objective optical element, the spherical aberration is corrected against BD whose protective layer thickness is 0.100 mm. With regard to the light beam of 655 nm (as the wavelength) passing through the objective optical element, the spherical aberration is corrected against DVD whose protective layer thickness is 0.6 mm.

When both negative lens BEa and positive lens BEb are positioned near the objective optical element, positive lens BEb emits diverging light with low divergent degree. With regard to the light beam passing through the objective optical element, the spherical aberration against BD whose protective layer is 0.075 mm thick is corrected.

When both negative lens BEa and positive lens BEb are positioned near the light source, positive lens BEb emits diverging light of high exitance. With regard to the light beam passing through the objective optical element, the spherical aberration against CD whose protective layer thickness is 1.2 mm is corrected.

As above described, this embodiment determines the positions of two movable optical elements in a two-point switching manner by butting the actuators to the positioning member. Therefore, this method requires no positioning sensor and consequently makes the control circuit simple.

Further, this embodiment can reduce the difference in the spherical aberration of a 2-layer type DVD which is caused by the thickness of the protective layer between 2 layers of the DVD by changing the position of the negative lens BEa according to the layers.

In this embodiment, negative lens Bea is moved to correct the spherical aberration caused by the thickness of the protective layer between two layers and positive lens Beb is moved to correct the spherical aberration caused by the difference between protective layer thicknesses of BD and CD. However, it is possible to design negative lens BEa and positive lens BEb to reverse their roles.

The objective optical element can be a lens whose spherical aberration is corrected relative to the thickness of a protective layer of 0.0875 mm thick which is equivalent to the thickness of the protective layer sandwiched by two layers of BD when infinite light of 407 nm (as the wavelength) is applied. In this case, negative lens BEa and positive lens BEb can be designed so that the light beam passing through positive lens BEb becomes a converging light beam of low convergence on the thin protective layer of BD and a diverging light beam of low divergent degree against the thick protective layer of BD.

The light beams incident to beam expander BE may be infinite light beams or finite light beams.

As explained above, the first divergent angle changing element is BEa and the second divergent angle changing element is BEb in this embodiment.

In the above description, beam expander BE made with a positive lens and a negative lens is used as an example, but it can be a system having lenses both of which have positive refractive forces.

And as described above, it is possible to use driving of beam expander BE for an information recording medium having two recording layers.

And it is possible to employ a coupling lens or collimator lens in the optical path (besides BE) as the first or second divergent angle changing element. (Ninth aspect of the invention).

In this case, various optical systems can be built by combining refractive forces, for example by combinations to be stated in tenth to fourteenth aspects of the invention.

### Third Embodiment

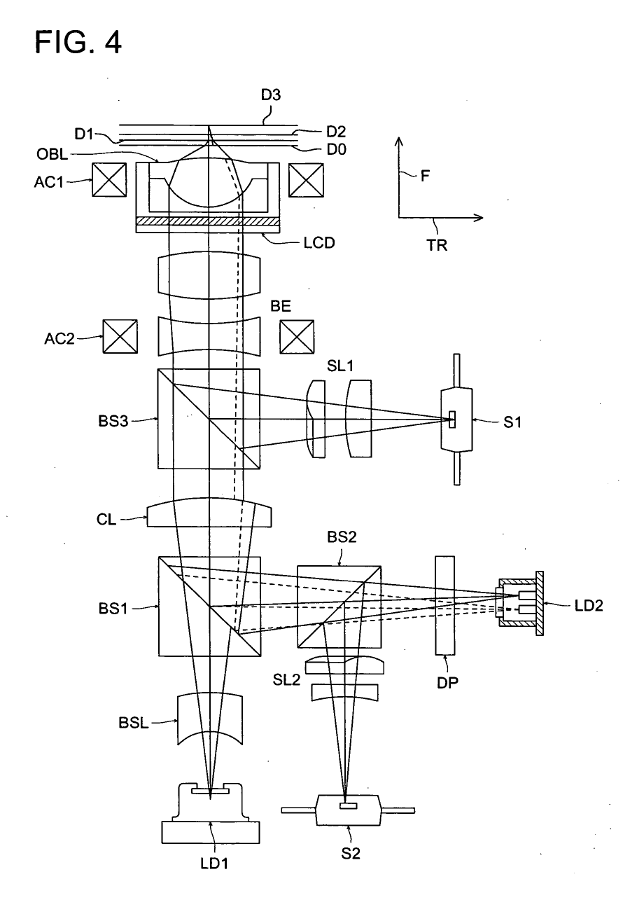

Referring to FIG. 4, from fifteenth to nineteenth aspects of the invention will be explained below.

The third embodiment is partially identical to the first embodiment. The same elements (including functions and actions) are given the same reference numbers.

This embodiment employs a concave lens of beam expander BE as the first divergent angle changing element capable of moving forward and backward along the optical axis. Similarly to the first embodiment, in this embodiment, movement of the first divergent angle changing element corrects the spherical aberration caused by the difference in protective layer thicknesses or the spherical aberration caused by differences in service waveforms by moving the concave lens along the optical axis.

Therefore, the compatibility across the different formats of information recording media is secured to this embodiment. However, coma aberration caused by tracking operation of the objective optical element must be eliminated.

Similarly to the first embodiment, this embodiment gives a spherical aberration to the light beam incident to objective optical element OBL and thus eliminates the coma aberration. This function is implemented by an aberration correction element in which the quantity of generated aberration is varied based on an electric signal applied thereto. (Fifteenth aspect of the invention).

In this embodiment, liquid crystal element LCD as an aberration correction element is provided closer to the light source rather than objective optical element OBL side. (Sixteenth aspect of the invention).

In an optical pickup illustrated in FIG. 4, objective optical element OBL and liquid crystal element LCD are integrated and driven to focusing and tracking directions by 2-axis actuator AC1. Liquid crystal element LCD is connected to a power supply section (not shown in the drawing) and a control section, and can generate different aberrations mainly in the tracking direction according to the applied voltage and current.

In order to give liquid crystal element LCD to generate coma aberration in the tracking direction, at least two areas in which the coma aberration is generated independently are formed in the tracking direction. (Seventeen aspect of the invention).

And when objective optical element OBL and aberration correction element LCD are integrated, the light beam going out from LCD is made to have a coma aberration whose phase is opposite to that of the coma aberration caused by tracking. (Eighteenth aspect of the invention).

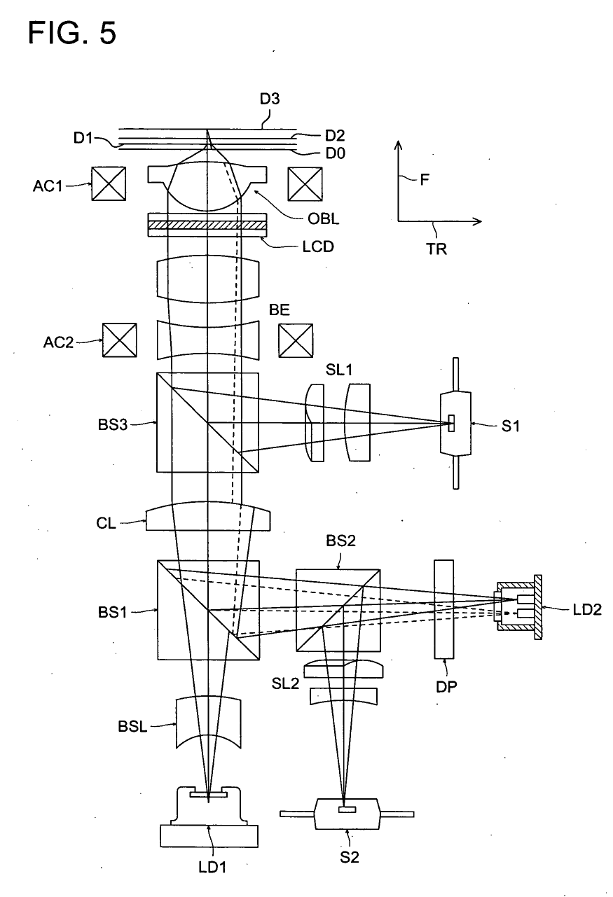

Contrarily, it is also possible to separately build objective optical element OBL and liquid crystal element LCD which is an aberration correction element as shown in FIG. 5. This configuration can downsize the bobbin of the actuator AC1. In this case, when objective optical element OBL is driven by actuator AC1 in a focusing and a tracking directions, the light beam outputted from LCD diagonally enters objective optical element OBL.

In such a case, generation of coma aberration is suppressed by making the light beam from liquid crystal element LCD have a spherical aberration to excessively correct the coma aberration. (Nineteenth aspect of the invention).

### Fourth Embodiment

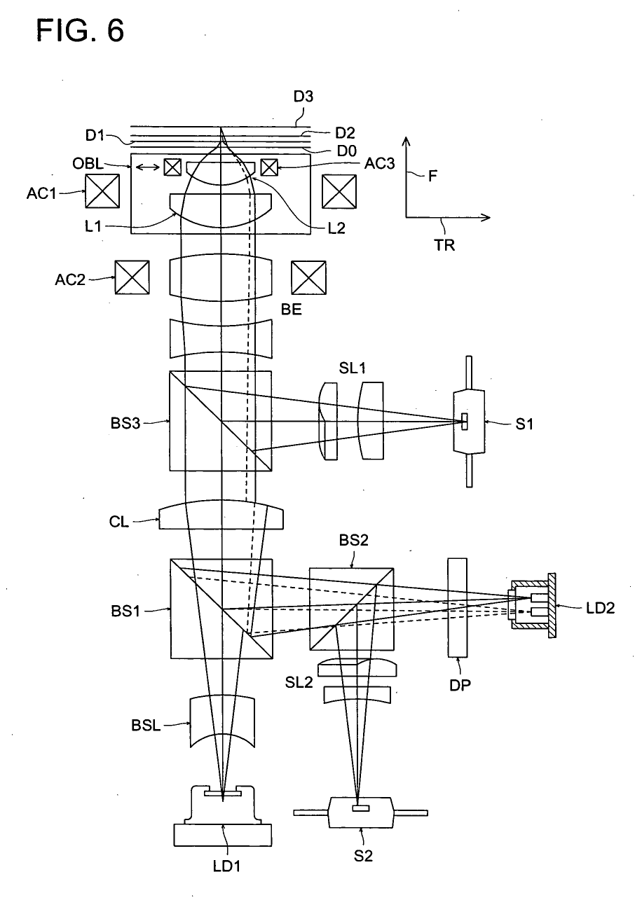

Referring to FIG. 6, other aspect of the invention will be explained below.

The fourth embodiment is partially identical to the first aspect. The same elements (including functions and actions) are given the same reference numbers.

This embodiment employs a convex lens of beam expander BE as the first divergent angle changing element moving forward and backward along the optical axis. Similarly to the first aspect, in this embodiment, the spherical aberration caused by the difference in protective layer thicknesses or the spherical aberration caused by differences in waveforms being used is corrected by moving the convex lens along the optical axis. Naturally, this embodiment can be so constructed to move a concave lens forward and backward.

Therefore, the compatibility across the different formats of information recording media is secured to this embodiment. However, generation of the coma aberration caused by tracking operation of the objective optical element must be eliminated.

In this embodiment, objective optical element OBL is made up with two optical elements. Objective optical element OBL generates a coma aberration by changing their relative positions and allows this coma aberration to compensate the coma aberration caused by tracking operation.

In an optical pickup apparatus shown in FIG. 6, objective optical element OBL is a unit made up with a convex lens as the first element L1 and another convex lens L2 as the second element. The first element L1 can be a concave lens by optical designing.

And the units constituting the objective optical element are supported and driven in a body by actuator AC1 in focusing and tracking directions. In the unit, L2 is driven by another actuator AC3 to shift in the tracking direction.

When the whole objective optical element is locked in tracking servo loop, L2 as the second element in the objective optical element is shifted properly to intentionally to generate a coma aberration having a opposite polarity to that of the coma aberration generated by the diagonally-incoming light beam. Accordingly, the coma aberration can be compensated. For example, second element L2 is moved in a direction opposite to the direction in which the whole objective optical element OBL is driven by AC1 which is a tracking device.

It is also preferable to shift, for example, the first element L1 in the tracking direction. Further, it is also preferable to enable both L1 and L2 to shift.

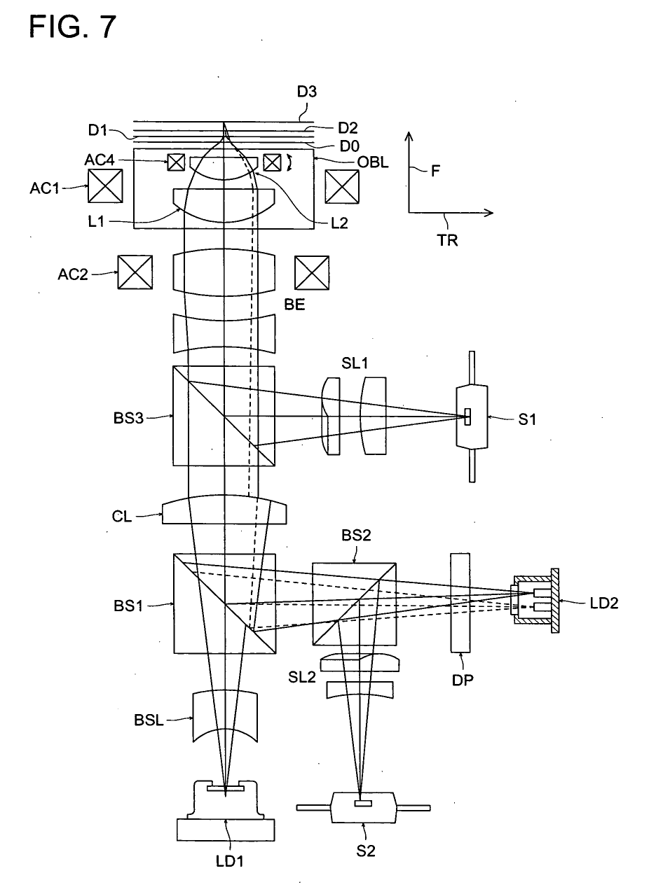

As shown in FIG. 7, it is also preferable to tilt the optical axis of second optical element L2 by actuator AC4. Further, it is also preferable to combine the element-shifting configuration and the optical-axis tilting configuration.

As explained above, it is the first divergent angle changing element that corrects the spherical aberration caused by differences in disc thickness. Although this function is done mainly by one of the optical elements structuring the beam expander in the above embodiments, it can also be done by the coupling lens or collimator lens. (Twentieth aspect to twenty first aspect of the invention) Particularly, when using a light source unit which assembles three light sources in a body, optimum divergent angles of out-going light beams are formed to respective wavelengths by moving the coupling lens forward and backward along the common optical path. And as already explained, it is possible to make one of the optical elements of the beam expander play this role Although, in each of the above embodiments, the beam expander is made up with a set of concave and convex lenses, it can be made up with a set of convex lenses.

A preferable configuration being common to the first to fourth embodiments will be explained below.

As explained above, the spherical aberration increases as the protective layer becomes thicker. To correct this, the above configurations respectively move the coupling lens or beam expander forward and backward along the optical axis to change the angle of divergence of the light beam which enters the objective optical element and eliminate the aberration. This can secure a working distance. In this case, it is preferable to optimize objective optical element OBL to the first information recording medium (Twenty fourth asptect of the invention) and to apply infinite parallel light to the first information recording medium that requires large aperture and large amount of light beams. A diverging light beams are applied to the other information recording media to correct the spherical aberration. Therefore, at least one of magnifications m1, m2, and m3 of objective optical element OBL to the first, second, and third light sources is not 0. (Twenty fourth aspect of the invention).

Objective optical element OBL made up with a single lens is preferable because it is simple in structure and can reduce assembling errors. (Twenty fifth aspect of the invention).

It is also preferable to build up objective optical element OBL with two optical elements having refractive forces. (Twenty sixth aspect of the invention) In this case, the viewing angle of each objective optical element can be made smaller than that of a single lens. This is better for lens production. Further, this has a merit of improving the basic off-axis characteristic.

In this case, it is preferable to use a plastic lens as the optical element near the light source and a glass lens as the optical element near the information recording medium or to use plastic lenses as the optical elements. However, the optical element near the information recording medium should preferably be made of a material whose refraction index will be affected little by temperature. Further, the optical element near the information recording medium is apt to receive a lot of light energy in the surface opposite to the information recording medium and the surface will be damaged easily. Therefore, the surface should preferably be protected by a reflection preventing coating or made of a material which is hard to be damaged.

Further, objective optical element OBL should preferably be available not only to the first information recording medium but also to both first and second information recording media. (Twenty seventh aspect of the invention) In this case, the structure should be so designed to give an optical path difference according to the wavelength difference since different wavelengths are used. Further, to use ample light intensity and to reduce the coma aberration caused by tracking operation, it is preferable to apply infinite parallel light to both first and second information recording media.

As examples of structures that give optical path differences according to wavelength differences, listed are a wavelength selective diffraction element, a diffraction element which outputs diffraction light beams of different orders for respective wavelengths of the light beam, and a structural element which gives different phase differences for respective wavelengths of the light beam. (Twenty eighth aspect to thirtieth aspect of the invention).

A representative one of such structures is a saw-teeth shape diffraction structure of twenty-ninth aspect of the invention.

This structure has concentric rings with fine intervals (pitches) around the optical axis. Light beams passing through areas adjoining rings are given a predetermined optical path difference.

Different light spots can be formed on information recording media by setting the pitch (diffraction power) and depth (blazed wavelength) of the saw teeth. For example, a light beam from the first light source of a specific NA is formed as a light spot by an eightic diffraction light on the first information recording medium and a light beam from the second light source in the same NA is formed as a light spot by a fivetic diffraction light on the second information recording medium. However, a light beam coming from the outer area (of a specific NA or more) can form a light spot on the DVD but does not form a light spot on the CD (because it becomes flared).

In this way, by using light beams of different diffraction orders, the diffraction efficiency can be increased in each case and secure the light amount.

This diffraction structure is an example of optical-path-difference giving structure however, a well-known “phase difference giving structure” and “wavelength selective diffraction element (also called a multi-level structure)” also may be used.

The phase difference giving structure and its examples are disclosed in the form of a ring phase corrective object lens method in Japanese Non-Examined Patent Publication H11-2759 and Japanese Non-Examined Patent Publication H11-16190.

The structure disclosed in Japanese Non-Examined Patent Publication H11-2759 optimizes the basic object lens surface for DVD recording and reproduction and uses a phase correction method for CD recording and reproduction. In other words, concentric rings are formed on the surface of an object lens which is designed to minimize the wavefront aberration in the DVD system. This can reduce the wavefront aberration in the CD system while suppressing the increase of the wavefront aberration in the DVD system.

In this technology, the phase control element hardly changes the phase distribution of the DVD wavelength. Therefore, the RMS wavefront aberration can remain as a value of an object lens which is designed to be optimum for the DVD system and works to reduce the RMS wavefront aberration in the CD system. Consequently, this technology is effective for the DVD system whose recording and reproduction performance is sensitive to the wavefront aberration.

Contrarily, Japanese Non-Examined Patent Publication H10-334504 discloses a phase correction method which optimizes the optical performance of the basic object lens for CD recording and reproduction and uses a phase correction method for DVD recording and reproduction.

These technologies improves the RMS (Root Mean Square) wavefront aberration in both DVD and CD recording and reproduction.

As for the ring phase corrective object lens, Japanese Non-Examined Patent Publication H11-16190, for example, has disclosed a case that determins the surface of the basic object lens so that it may be optimum for recording and reproduction of an optical disc, assuming that the thickness of the disc is between CD and DVD thicknesses, and corrects RMS (Root Mean Square) wavefront aberration of CD and DVD by a phase correction method.

Japanese Non-Examined Patent Publication 2001-51192 discloses a method of making the RMS (Root Mean Square) wavefront aberration smaller by changing the ring pitches and surface shapes and thus converging the light beam into a point. “Wavelength selective diffraction element (also called multi-level structure)” periodically repeats a predetermined number of stair-like steps. So it is also called a convolution type diffraction structure. The number of stair-like steps, step height, and width (pitch) can be set adequately as disclosed for example in Japanese Non-Examined Patent Publication 9-54973. This stair-like structure enables generation of diffraction effects selective to a plurality of wavelengths. This stair-like structure does not give any diffraction to the other wavelengths and consequently, gives no optical effect to them.

Further, this technology employs an optical-path-difference giving structure to correct the spherical aberration caused by differences in disc thicknesses of optical disc formats. Naturally, this technology is also available to correct aberrations caused by changes in refraction index at ambient temperature, and aberrations caused by differences and fluctuation (mode hop) in wavelengths in use. As for aberrations caused by wavelength differences, the former corrects the spherical chromatic aberration caused by wavelength differences of 50 nm or more and the latter corrects aberrations caused by minute wavelength fluctuations of up to 5 nm.

Although this example provides the diffraction structure on the objective optical element, it can naturally be provided on the other element such as a collimator and a coupling lens.

It is most preferable to use such a material for optical elements which have refraction and aspheric surfaces.

### Fifth Embodiment

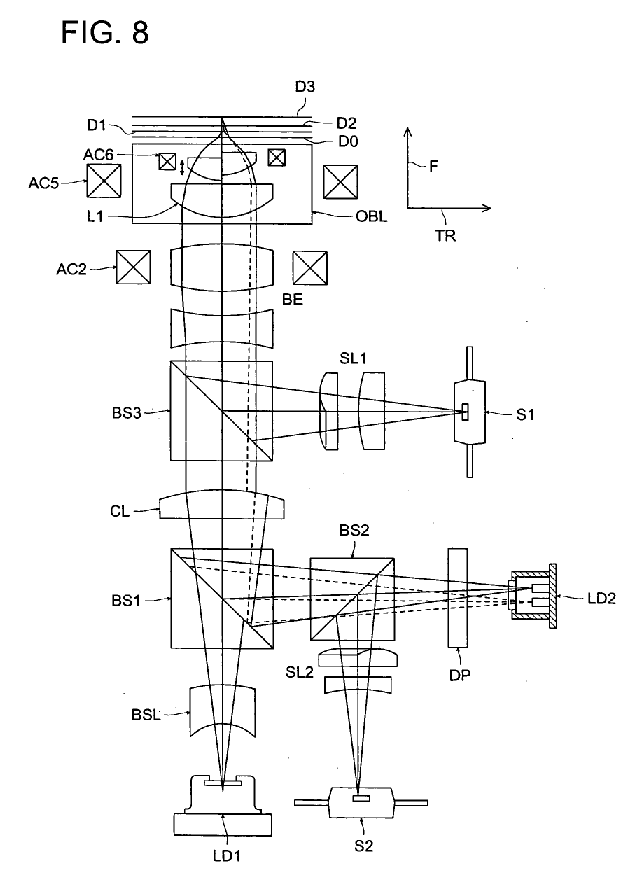

Referring to FIG. 8, other aspects of the invention will be explained below.

The fifth embodiment is partially identical to the first embodiment. The same elements (including functions and actions) are given the same reference numbers.

In this embodiment, objective optical element OBL is structured with two optical elements (first element L1 and second element L2) having different refraction forces, and the group-distances between the first element L1 and the second element L2 can be changed. These elements L1 and L2 are supported together by a bobbin (not shown in the drawing) to keep the between-groups-distance constant in focusing and tracking operations.

Now, the above-described embodiments respectively change the degree of divergence (exitance) of a light beam which enters the objective optical element to correct spherical aberrations caused by differences in protective layer thicknesses or spherical aberrations caused by differences in service wavelengths. However, in the fifth embodiment, the refraction force of the objective optical element is changed to form a light spot optimum for each information recording medium and keeps the elements in a body for tracking operation. Therefore, this embodiment can reduce the change in the angle of divergence of the light beam incident to the whole objective optical element (OBL). Consequently, little coma aberration generates in the tracking operation. This is very preferable.

The distance between first and second elements L1 and L2 is dependent upon the formats of information recording media. Usually, the group distance is made longer as the protective layer is thicker and made shorter as the protective layer is thinner. By determining the group distance, the refraction force is weaken or strengthened and alight spot optimum for respective information recording media is formed.

In this example, only second element L2 moves forward and backward along the optical axis. However, it is also preferable only first element L1 moves forward and backward along the optical axis or both first and second elements (L1 and L2) move forward and backward along the optical axis.

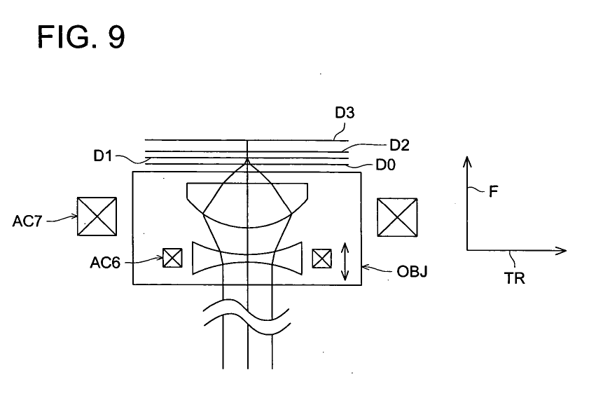

Further, the second element should preferably be a positive lens. Particularly, a positive lens having a refraction surface near the light source and an almost flat surface near the information recording medium can improve the wavefront of the converging light spot. Further, the first element can be a positive lens or a negative lens. In FIG. 9, the second element is a negative lens (concave lens) and moves forward and backward along the optical axis.

And this invention can make the magnifications of all light beams incident to objective optical element OBL equal to each other. This can simplify the whole optical system. Particularly, by using infinite parallel light beams for all incident light beams, the light intensity loss can be reduced.

As for magnifications of light beams incident to objective optical element OBL, the first and second light sources can be infinite parallel light sources and the third light source can be a finite diverging light source. This can reduce light intensity losses for the first and second information recording media that require accuracies in light intensity losses and light spot forming performance. Further, this can secure a working distance for the third information recording medium.

Further, the first light source can be an infinite parallel light source and the second and third light sources can be finite diverging light sources. Also in this case, optimum converging light spots can be formed by setting an adequate group distance of the objective optical element.

Further, the first light source can be a finite converging light source and the third light source can be a finite diverging light source. In this case, the second light source can be a light source of finite converging, infinite parallel, or finite diverging light.

Further it is possible to provide a divergent angle changing element between the light source and the objective optical element to adjust the angle of divergence of a light beam if necessary. It is also possible to cause all light sources to emit infinite parallel light beams.

Further, it is also possible to apply the above-described optical-path-difference giving structures and correct aberrations caused by various factors.

Although respective embodiments are described mainly assuming that the light source unit is made up with two separate parts, all inventions can use an optical system using a light source unit which contains from the first to the third light sources in a body as explained by the first embodiment in reference to FIG. 2.

Although each of the above examples uses beam shaper BSL, it is possible to provide a light intensity distribution changing element which changes the intensity distribution of incident light beam near the light source. This light intensity distribution changing element is an optical element which mainly receives a light beam of a Gaussian distribution and outputs light beams of different light intensity distributions. This optical element can make the light intensity distributions of the radiated light beams approximately uniform according to requirements and control the light intensity on the outermost edge of the radiated light beam to 45 to 90% of the light intensity near the optical axis.

Next is a numeric example of an optical system which reads/writes from/onto two information recording media by using an objective optical element and read/writes another information recording media by moving part of the beam expander forward and backward along the optical axis. The aspheric surface of this embodiment is expressed by Equation (1) to which aspheric surface coefficients A₂ᵢ of Table 1 is assigned.
X=(h²/r)/{square root over ((1−(1+κ)(h/r)²)+A₂h²+A₄h⁴+A₆h⁶+ . . . )} (1)
where
X (mm): Quantity of deformation of the aspheric surface from the plane which is tangent to its vertex
h (mm): Height perpendicular to the optical axis
r (mm): Curvature radius
κ: Cone modulus

This embodiment uses a convolution type diffraction structure which is a wavelength selective diffraction structure. This is expressed by an optical path difference which is added to the transmission wavefront. The optical path difference function φ_{b} (mm) is defined by Equation (2).
φ_{b}=(λ/λ_{B})×n×(B₂h²+B₄h⁴+B₆h⁶+ . . . ) (2)
where
λ: Wavelength of incident light beams
λ_{B}: Production wavelength
h (mm): Height perpendicular to the optical axis
B₂ⱼ: Modulus of the optical path difference function
n: Diffraction order

NA2, f1, λ1, m1, and t1 in Table 1 are respectively numerical aperture, focal distance, wavelength, magnification of object optical system OBJ, and thickness of a protective layer when a “high density optical disc” is used. Similarly, NA2, f2, λ2, m2, and t2 in Table 1 are values when a DVD is used. NA3, f3, λ3, m3, and t3 in Table 1 are values when a CD is used.

r (mm) is a curvature radius. d1 (mm), d2 (mm), and d3 (mm) are respectively lens-to-media distances for the use of “high density optical disc,” DVD, and CD in that order. Nλ1, Nλ2, and Nλ3 are respectively refraction indexes of lens to wavelengths λ1, λ2, and λ3. νd is an Abbe number of lens to the d-ray.

n1, n2, and n3 are respectively diffraction orders of the first, second, and third diffraction light beams that generate in the convolution type diffraction structures. The optical system of the embodiment is made up with an expander lens comprising negative and positive plastic lenses and an object optical system comprising an aberration correcting element and a light collecting element which are both plastic lenses. Their practical numeric data is listed in Table 1.

TABLE 1
Optical specifications
f1 = 2.200, NA1 = 0.85, λ1 = 408 nm, d2 = 3.0000, d8 = 0.7190,
d9(t1) = 0.0875
f2 = 2.278, NA2 = 0.65, λ2 = 658 nm, d2 = 3.1800, d8 = 0.4770,
d9(t2) = 0.6
f3 = 2.275, NA3 = 0.45, λ3 = 785 nm, d2 = 0.2000, d8 = 0.4290,
d9(t3) = 1.2
Paraxial data

| Plane | | | | | | | Re- |
|---|---|---|---|---|---|---|---|
| number | r (mm) | d (mm) | Nλ1 | Nλ2 | Nλ3 | νd | marks |
| OBJ | | ∞ | | | | | Lumi- |
| | | | | | | | nous |
| | | | | | | | point |
| 1 | −1.0991 | 0.8000 | 1.5242 | 1.5064 | 1.5050 | 56.5 | Ex- |
| 2 | 1.9354 | d2 | | | | | pander |
| 3 | ∞ | 1.5000 | 1.5242 | 1.5064 | 1.5050 | 56.5 | lens |
| 4 | −2.8923 | 15.000 | | | | | |
| STO | | 0.5000 | | | | | Ap- |
| | | | | | | | erture |
| 5 | ∞ | 1.0000 | 1.5242 | 1.5064 | 1.5050 | 56.5 | Object |
| 6 | ∞ | 0.1000 | | | | | optical |
| 7 | 1.4492 | 2.6200 | 1.5596 | 1.5406 | 1.5372 | 56.3 | system |
| 8 | −2.8750 | d8 | | | | | |
| 9 | ∞ | d9 | 1.6211 | 1.5798 | 1.5733 | 30.0 | Pro- |
| 10 | ∞ | | | | | | tective |
| | | | | | | | layer |

TABLE 2
Aspheric coefficients

| | 1st plane | 2nd plane | 4th plane | 7th plane | 8th plane |
|---|---|---|---|---|---|
| κ | −0.10191E+01 | 0.11413E+01 | −0.42828E+00 | −0.65249E+00 | −0.43576E+02 |
| A4 | −0.54020E−01 | −0.59836E−01 | −0.29680E−04 | 0.77549E−02 | 0.97256E−01 |
| A6 | 0.00000E+00 | 0.00000E+00 | 0.00000E+00 | 0.29588E−03 | −0.10617E+00 |
| A8 | 0.00000E+00 | 0.00000E+00 | 0.00000E+00 | 0.19226E−02 | 0.81812E−01 |
| A10 | 0.00000E+00 | 0.00000E+00 | 0.00000E+00 | −0.12294E−02 | −0.41190E−01 |
| A12 | 0.00000E+00 | 0.00000E+00 | 0.00000E+00 | 0.29138E−03 | 0.11458E−01 |
| A14 | 0.00000E+00 | 0.00000E+00 | 0.00000E+00 | 0.21569E−03 | −0.13277E−02 |
| A16 | 0.00000E+00 | 0.00000E+00 | 0.00000E+00 | −0.16850E−03 | 0.00000E+00 |
| A18 | 0.00000E+00 | 0.00000E+00 | 0.00000E+00 | 0.44948E−04 | 0.00000E+00 |
| A20 | 0.00000E+00 | 0.00000E+00 | 0.00000E+00 | −0.43471E−05 | 0.00000E+00 |

Optical path difference function modulus

| | 5th plane |
|---|---|
| n1/n2/n3 | 0/1/0 |
| λB | 658 nm |
| B2 | 3.6500E−03 |
| B4 | −1.0196E−03 |
| B6 | 1.6630E−05 |
| B8 | −9.3691E−05 |
| B10 | 9.0441E−06 |

The object optical system is made of a HD/DVD compatible lens which corrects a spherical aberration caused by a difference in thicknesses of protective layers of the “high density optical disc” and DVD by the action of a convolution type diffraction structure which is provided on the optical surface (the 5th plane in Table 1) of the aberration correcting element near the light source. The light collecting element is a lens whose spherical aberration correction is optimized to the “high density optical disc.”

This convolution type diffraction structure is made up with a plurality of concentric rings. Each ring is divided into five stair-like parts. The step height of the stair-like part (δ) is expressed by
δ=2×λ1/(N_{λ1}−1) (3)
where

λ1 is a refraction index of the aberration correcting element L1 at wavelength λ1. Since this stair-like structure gives optical path difference 2λ1 to the first light beam, the first light beam can pass through the convolution type diffraction structure without being affected by the structure. Further, since this stair-like structure gives optical path difference 1λ3 to the third light beam, the third light beam can also pass through the convolution type diffraction structure without being affected by the structure. Contrarily, this stair-like structure gives optical path difference approx. 0.2λ2 to the second light beam. Therefore, this means that a single 5-divided ring gives an optical path difference of 1λ2. As the result, a primary diffraction light generates. By selectively diffracting only the second light beam in this way, the spherical aberration due to the difference between thicknesses t1 and t2 is corrected.

This convolution type diffraction structure actually shows very high diffraction efficiencies: for example, 100% for the 0-order diffraction light (transmission light) of the first light beam, 87% for the 1-order diffraction light of the second light beam, and 100% for the 0-order diffraction light (transmission light) of the third light beam.

Further, the spherical aberration due to the difference in protective layer thicknesses of the “high density optical disc” and CD is corrected by moving the negative lens so that the distance between the positive and negative lenses of the expander lens may be greater than that for the “high density optical disc” to vary the magnification of the object optical system.

Further, when the wavelength of an incident light beam varies, the exitance of the light beam coming out of the expander lens varies because of the chromatic aberration. To prevent this in DVD recording and reproduction, the negative lens is moved so that the second light beam coming out of the expander lens may be parallel and the distance between the positive and negative lenses of the expander lens may be greater than that for the “high density optical disc”.

1. An optical pickup apparatus, comprising:
a first light beam source for emitting first light beams having wavelength λ1 for reproducing and recording information from and onto a first recording medium having a first protective layer of thickness t1;
a second light beam source for emitting second light beams having wavelength λ2 (λ1<λ2) for reproducing and recording the information from and onto a second recording medium having a second protective layer of thickness t2 (t1<t2);
a third light beam source for emitting third light beams having wavelength λ3 (λ2<λ3) for reproducing and recording the information from and onto a third recording medium having a third protective layer of thickness t3 (t2<t3);
an objective optical lens for converging the first light beams, the second light beams and the third light beams onto respective recording surfaces of the first recording medium, the second recording medium and the third recording medium;
a tracking device for moving the objective optical lens in a tracking direction being perpendicular to an optical axis direction of the objective optical lens;
a first divergent angle changing element for changing a divergent angle of light beams incident to the objective optical element, the divergent angle changing element being capable of moving in an optical axis direction of the first angle changing element and placed in an optical path from the first, second and third light beam sources to the objective optical element; and
a coma aberration correction element for correcting coma aberration caused when the tracking device moves the objective optical element, the coma aberration correction element being placed in the optical path.

2. The optical pickup apparatus of claim 1,
wherein the coma aberration correction element is second divergent angle changing element for generating spherical aberration corresponding to a moving amount of the coma aberration correction element placed in the optical path, the first divergent angle changing element moves in the optical axis direction of the first divergent angle changing element corresponding to a information recording medium to be reproduced from or recorded to so that the first divergent angle changing element cancels out spherical aberration caused by a difference between the first protective layer, the second protective layer and the third protective layer, and
the second divergent angle changing element moves in an optical axis direction of the second divergent angle changing element so as to cancel out the coma aberration caused when the tracking device moves the objective optical element.

3. The optical pickup apparatus of claim of claim 2,
wherein the first divergent angle changing element changes a divergent angle of light beams emitted from the first light beam source second light beam source and the third light beam source and outputs the light beams when the first divergent angle changing element is moved in the optical axis direction of the first divergent angle changing element.

4. The optical pickup apparatus of claim of claim 2,
wherein the first divergent angle changing element is moved in the optical axis direction of the first divergent angle changing element to output light beams emitted from the first light beam source, the second light beam source and the third light beam-source, without changing a divergent angle of the first light beams, the second light beams and third light beams.

5. The optical pickup apparatus of claim 2,
wherein at least the coma aberration caused when the objective optical element is moved by the tracking device when reproducing or recording information from or to the third recording medium is smaller than spherical aberration caused when light beams of spherical wave are guided into the objective optical element.

6. The optical pickup apparatus of claim 2,
wherein the spherical aberration caused by moving the second divergent angle changing element in the optical axis direction of the second divergent angle changing element is greater than what is required for correcting the coma aberration.

7. The optical pickup apparatus of claim 2,
wherein the second divergent angle changing element includes at least an aspheric surface whose quartic aspheric coefficient is not zero.

8. The optical pickup apparatus of claim 7,
wherein at least one of sextic, eightic and tentic aspheric surface coefficients of the aspheric surface is not zero.

9. The optical pickup apparatus of claim 2,
wherein one of the first converging angle changing element and the second converging angle changing element is an element is a coupling lens and the other is an element which structures a beam splitter.

10. The optical pickup of claim 9,
wherein the coupling lens is a collimator lens.

11. The optical pickup apparatus of claim 2,
wherein the first divergent angle changing element and the second divergent angle changing element have an equal refractive power.

12. The optical pickup apparatus of claim 2,
wherein the first divergent angle changing element and the second divergence changing element have different refractive powers.

13. The optical pickup apparatus of claim 2,
wherein the first divergent angle changing element is one of two elements structuring an expander and the second divergent angle changing element is the other element structuring the expander.

14. The optical pickup apparatus of claim 13,
wherein the first divergent angle changing element and the second divergent angle changing element have different polarities of diffractive powers.

15. The optical pickup apparatus of claim 1,
wherein the coma aberration correction element is provided in between the first, second and third light beam sources, and the objective optical element, the coma aberration correction element being an aberration element for generating spherical aberration based on an amount of electrical signal implied to the coma aberration element;
the first divergent angle changing element moves in the optical axis direction corresponding to a information recording medium so that the first divergent angle element cancels out first spherical aberration caused by a difference between the first protective layer, the second protective layer and the third protective layer; and
the electrical signal is changed so as to cancel out the coma aberration caused when the tracking device moves the objective optical element.

16. The optical pickup apparatus of claim 15,
wherein the aberration correction element is structured by a liquid crystal element.

17. The optical pickup apparatus of claim 15,
wherein the aberration correction element has at least two regions which can be independently controlled for canceling out the first spherical aberration.

18. The optical pickup apparatus of claim 15,
wherein the objective optical element and the aberration correction element are integrated, and light beams outputted from the aberration correction element is made to have coma aberration whose phase is opposite to that of the coma aberration caused by a tracking operation of the objective optical element.

19. The optical pickup apparatus of claim 15,
wherein the objective optical element and the aberration correction element are structured into different cases and light beams outputted from the aberration correction element has a spherical aberration being greater than what it required for correcting the coma aberration.

20. The optical pickup apparatus of claim 15,
wherein the first divergent angle changing element is a coupling lens.

21. The optical pickup apparatus of claim 20,
wherein the coupling lens is a collimator lens.

22. The optical pickup apparatus of claim 15,
wherein the first divergent angle changing element is one of elements structuring a beam splitter.

23. The optical pickup apparatus of claim 2,
wherein at least one of magnifications m1, m2, and m3 of the objective optical element corresponding to the first, second, and third light beam sources is not zero.

24. The optical pickup apparatus of claim 2,
wherein the objective optical element is optimized for reproducing and recording the information from and onto the first information recording medium.

25. The optical pickup apparatus of claim 2,
wherein the objective optical element is made up with a single lens.

26. The optical pickup apparatus of claim 2,
wherein the objective optical element is made up two lenses.

27. The optical pickup apparatus of claim 2,
wherein the objective optical element is capable of reproducing and recording, or reproducing or recording the information from or onto the first information recording medium and the second information recording media.

28. The optical pickup apparatus of claim 27,
wherein the objective optical element comprises a wavelength selective diffraction element.

29. The optical pickup apparatus of claim 27,
wherein the objective optical element comprises a diffraction element for outputting diffracted light beams having a different diffraction order for each wavelength for reproducing and or recording the first information recording medium and the second information recording medium.

30. The optical pickup of claim 27,
wherein the objective optical element comprises a phase difference giving structure element which gives phase differences for respective wavelengths for reproducing and recording the information from and onto the first information recording medium and the second information recording medium.
